(19) United States
(12) Patent Application Publication
(10) Pub. No.: US 2008/0000167 A1
(43) Pub. Date: Jan. 3, 2008

(54) Door Assembly

(76) Inventor: Hung-Ming Chen, Tucheng City (TW)

Correspondence Address: SHUI-CHOU CHOU, 230 SUNNYSIDE DRIVE, ROCHESTER, NY, 14623, US

(21) Appl. No.: 11/428,372

(22) Filed: Jun. 30, 2006

(51) Int. Cl. E06B 1/04

(52) U.S. Cl. 49/504

(57) ABSTRACT

A door assembly is described. The door assembly includes a door leaf, a door frame, a first rubber strip and a second rubber strip. The door leaf has an inner side and a peripheral side. The inner side and the peripheral side collectively form a first corner between the inner side and the peripheral side. The door frame is along the peripheral side and the inner side and on the first corner. The door frame has a fold on the inner side. The fold has an opening. The opening is toward the inner side and adjacent to the first corner. The first rubber strip is on the door frame and adjacent to the first corner. The second rubber strip is in the opening. The first rubber strip and the second rubber strip are respectively contacted with the first corner and the inner side after the door leaf is close to the door frame.

### BACKGROUND OF THE INVENTION

(1) Field of Invention

This invention relates generally to an architecture technology, and more particularly to a door assembly.

(2) Description of Related Art

Establishing a door must take notice of both functions and beauty. The functions may be closing air from diffusing outside a room, preventing water from flowing into the room, or preventing voice from transferring into the room. All those functions as well as beauty are frequently required by people.

To achieve those functions, someone skilled in the art may form some devices on a door leaf. Such formation may not meet the beauty requirement. It is a reason why people do not buy such kind of door.

Therefore, there is a need to provide a door assembly having above functions as well as beauty.

### BRIEF SUMMARY OF THE INVENTION

A door assembly is provided. The door assembly may include a door leaf, a door frame, a first rubber strip and a second rubber strip. The door leaf has an inner side and a peripheral side. The inner side and the peripheral side collectively form a first corner between the inner side and the peripheral side. The door frame is along the peripheral side and the inner side and on the first corner. The door frame has a fold on the inner side. The fold has an opening. The opening is toward the inner side and adjacent to the first corner. The first rubber strip is on the door frame and adjacent to the first corner. The second rubber strip is in the opening. The first rubber strip and the second rubber strip are respectively contacted with the first corner and the inner side after the door leaf is close to the door frame.

When one opens the door leaf to the outside, he may not notice the first rubber strip and the second rubber strip. The strips are not noticed, because most of the second rubber strip may be disposed in the opening, and because the first rubber strip is smaller than the second rubber strip and is distanced from the one opens the door leaf. The strips are not disposed on the door leaf, and therefore do not destroy the beauty of the door leaf of the present invention. The strips are not easily damaged by opening or closing the door leaf, because no hand or body may touch the door leaf when it is opened or closed.

### BRIEF DESCRIPTION OF SEVERAL VIEWS OF THE DRAWINGS

FIG. 1 is a cross-section of a door assembly according to a first embodiment of the present invention.

FIG. 2 is a cross-section of one flame retardant strip according to a first embodiment of the present invention.

FIG. 3 is a cross-section of another flame retardant strip according to a first embodiment of the present invention.

FIG. 4 is a cross-section of a second rubber strip according to a first embodiment of the present invention.

FIG. 5 is a cross-section of a door assembly according to a second embodiment of the present invention.

FIG. 6 is a cross-section of a door assembly according to a third embodiment of the present invention.

### DETAILED DESCRIPTION OF THE INVENTION

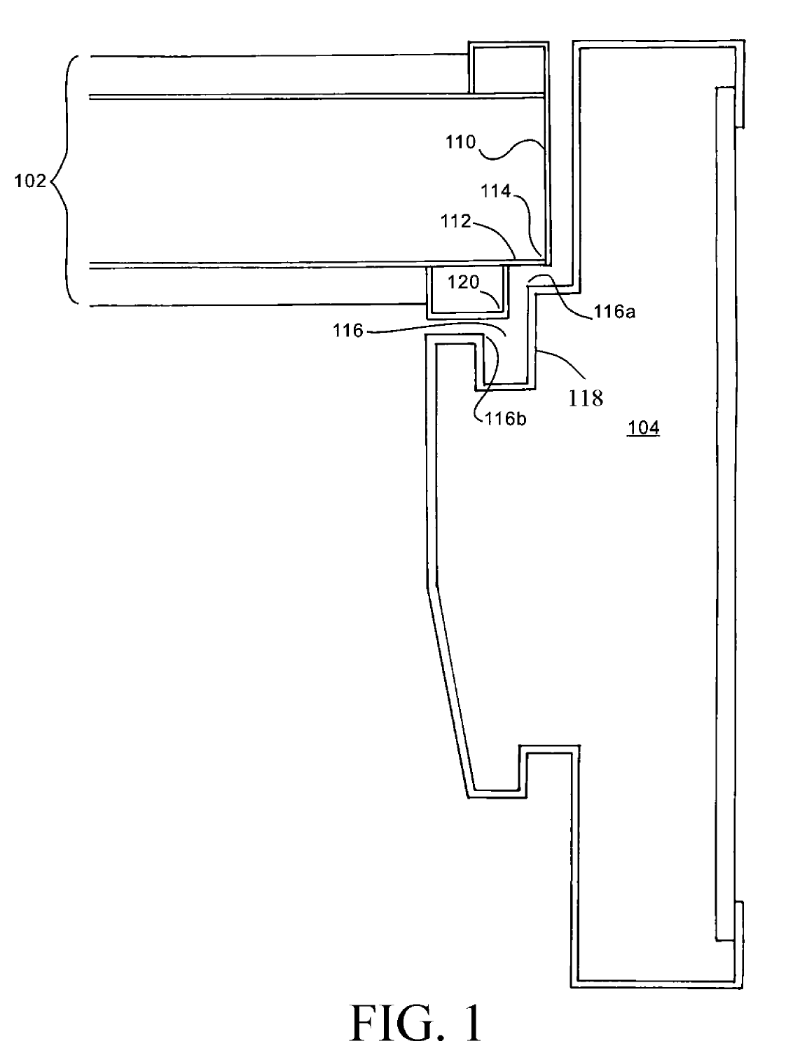

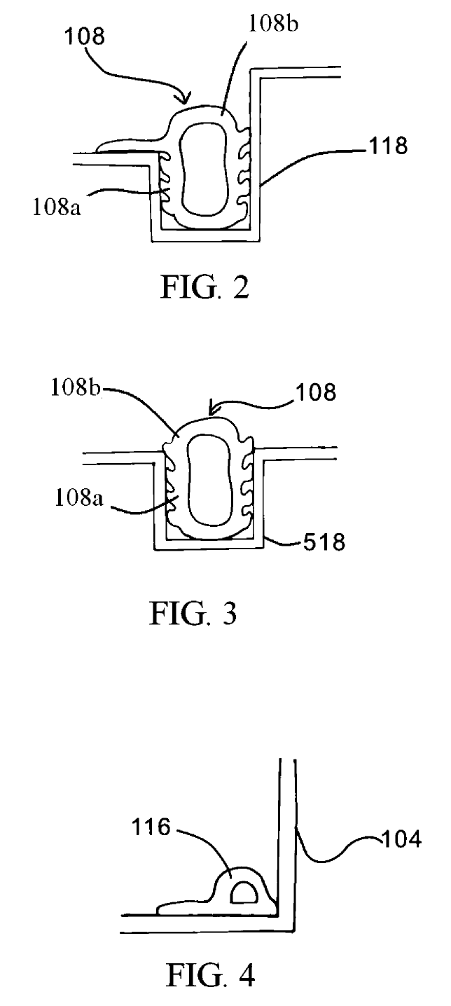

FIG. 1 is a cross-section of a door assembly according to a first embodiment of the present invention. Referring to FIG. 1, the door assembly may include a door leaf 103, a door frame 104, a first rubber strip 106 (FIG. 2) and a second rubber strip 108 (FIG. 4).

The door leaf 102 may have an inner side 112 and a peripheral side 110. The inner side 112 and the peripheral side 110 collectively form a first corner 114 between the inner side 112 and the peripheral side 110. The door frame 104, along the peripheral side 110 and the inner side 112 and on the first corner 114, the door frame 104 may have a fold 118 on the inner side 112. The fold 118 may have an opening 116. The opening 116 is toward the inner side 112 and adjacent to the first corner 114. The first rubber strip 106 is on the door frame and adjacent to the first corner. The second rubber strip 108 is in the opening 116.

The first rubber strip 106 and the second rubber strip 108 are respectively contacted with the first corner 114 and the inner side 112 after the door leaf 102 is close to the door frame 104. The door leaf 102 is close to the door frame 104 by, for example, closing the door leaf 102 to the door frame 104.

When one opens the door leaf 102 to the outside, he may not notice the first rubber strip 106 and the second rubber strip 108. The strips 106, 108 are not noticed, because most of the second rubber strip 108 is disposed in the opening 116, and because the first rubber strip 106 is smaller than the second rubber strip 108 and is distanced from the one opens the door leaf 102. The strips 106, 108 are not disposed on the door leaf 102, and therefore do not destroy the beauty of the door leaf 102 of the present invention.

The strips 106, 108 are not easily damaged by opening or closing the door leaf 102, because no hand or body may touch the door leaf 102 when it is opened or closed. The opening 116 may have a first side corner 116a and a second side corner 116b. Compared to the second side corner 116b, the first side corner 116a is closer to the first rubber strip 106. The first side corner 116a is as high as the second side corner 116b.

The inner side 112 of the door leaf 102 may have a second corner 120. The second corner 120 is preferably contacted with the second rubber strip when the door leaf 102 is closed. To achieve this contact, the first side corner 116a is preferably higher than the second side corner 116b.

The fold 118 may be a U-shaped fold. The U-shaped fold may have an outer width of about 13.6 mm. The opening 116 of such U-shaped fold preferably have a width of about 10 mm.

The second rubber strip 108 may be a flame retardant strip. One kind of the flame retardant strip is shown in FIG. 2. Most 108a of the second rubber strip 108 is disposed in the opening 116. A little 108b of the second rubber strip 108 is contacted with the inner side 112 of the door leaf 102. When the door assembly is experienced a fire, the second rubber strip 108 expands to keep being contacted with the door leaf 104 in a high temperature. The expansion prevents the flames or smokes from licking into a room through the door assembly of the present invention. On the other hand, the expansion prevents the flames or smokes from licking out of the door assembly if the fire is started inside the room.

One kind of the first rubber strip 106 is shown in FIG. 4. The first rubber strip 106 may eliminate noise. With the second rubber strip 108 and the first rubber strip 106, the air-closing effect is increased. If one of the strips 106, 108 is not contacted well enough, another of the strips 106, 108 may be well contacted to close the air.

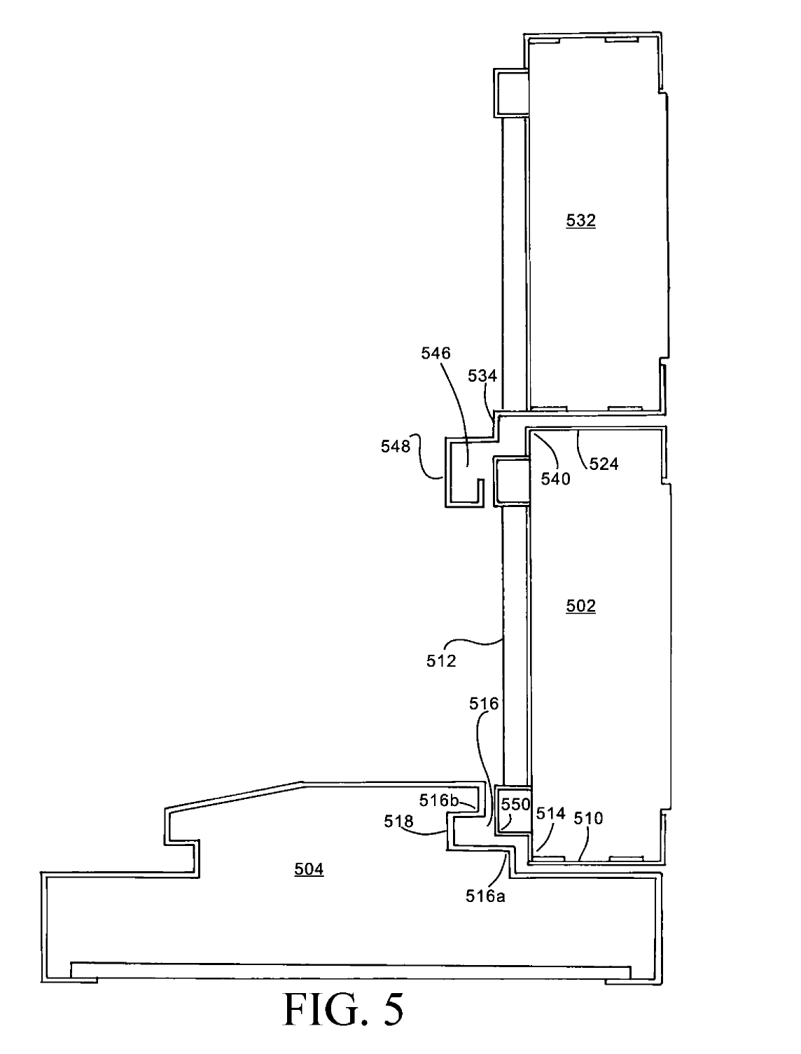

FIG. 5 is a cross-section of a door assembly according to a second embodiment of the present invention. Referring to FIG. 5, the door assembly may include a first door leaf 502, a door frame 504, a first rubber strip, a second rubber strip, a second door leaf 532, a doorpost 534, a third rubber strip and a fourth rubber strip. The first door leaf 502 may also be called parent door leaf. The second door leaf 532 may also be called children door leaf.

The forming method, shape and material of the first rubber strip may be the same as the first rubber strip 106 of the first preferred embodiment of the present invention. The forming method, shape and material of the second rubber strip may be the same as the second rubber strip 108 of the first preferred embodiment of the present invention. The forming method, shape and material of the third rubber strip may be the same as the first rubber strip 106 of the first preferred embodiment of the present invention. The forming method, shape and material of the fourth rubber strip may be the same as the second rubber strip 108 of the first preferred embodiment of the present invention

The first door leaf 502 may have an inner side 510, a first peripheral side 510 and a second peripheral side 524. The inner side 512 and the first peripheral side 510 collectively form a first corner 514 between the inner side 512 and the peripheral side 510. The inner side 512 and the second peripheral side 524 collectively form a second corner 540 between the inner side 512 and the second peripheral side 524.

The door frame 504 is disposed along the first peripheral side 510 and the inner side 512 and on the first corner 514. The door frame 504 may have a first opening 514 on the inner side 512. The first opening 516 may be toward the inner side 512 and adjacent to the first corner 514.

The first rubber strip may be on the door frame 504 and adjacent to the first corner 514. The second rubber strip is in the first opening 516. The second door leaf 532 may have a doorpost 534. The doorpost 534 is along the second peripheral side 524 and the inner side 512 and on the second corner 540. The doorpost 534 may have a second opening 546 on the inner side 512. The second opening 546 may be toward the inner side 512 and adjacent to the second corner 540.

The third rubber strip may be on the doorpost 534 and adjacent to the second corner 540. The fourth rubber strip may be in the second opening 546. The third rubber strip and the fourth rubber strip are respectively contacted with the second corner 540 and the inner side 512 after the first door leaf 502 is close to the door frame 504.

When one opens the door leaf 502 to the outside, he may not notice the first rubber strip, the second rubber strip, the third rubber strip and the fourth rubber strip. The strips are not noticed, because most of the second and fourth rubber strips are respectively disposed in the openings 516, 546, and because the first and third rubber strips are respectively smaller than the second and fourth rubber strips and are distanced from the one opens the door leaf 502. The strips are not disposed on the door leaf 502, and therefore do not destroy the beauty of the door leaf 502 of the present invention.

The opening 516 may have a first side corner 516a and a second side corner 516b. Compared to the second side corner 516b, the first side corner 116a is closer to the first rubber strip. The first side corner 516a is as high as the second side corner 516b. The inner side 512 of the door leaf 502 may have a third corner 550. The third corner 550 is preferably contacted with the second rubber strip when the door leaf 502 is closed. The first side corner 516a is preferably higher than the second side corner 516b.

The first fold 518 may be a U-shaped fold. The U-shaped fold may have an outer width of about 13.6 mm. The opening 116 of such U-shaped fold preferably have a width of about 10 mm.

The second rubber strip may be a flame retardant strip 108, as shown in FIG. 3. Most 108a of the second rubber strip 108 is disposed in the opening 116. A little 108b of the second rubber strip 108 is contacted with the inner side 512 of the door leaf 502. When the door assembly is experienced a fire, the second rubber strip 108 expands to keep being contacted with the door leaf 504 in a high temperature. The expansion prevents the flames or smokes from licking into a room through the door assembly of the present invention. On the other hand, the expansion prevents the flames or smokes from licking out of the door assembly if the fire is started inside the room.

One kind of the first rubber strip 106 is shown in FIG. 4. The first rubber strip 106 may eliminate noise. With the second rubber strip 108 and the first rubber strip 106, the air-closing effect is increased. If one of the strips 106, 108 is not contacted well enough, another of the strips 106, 108 may be well contacted to close the air.

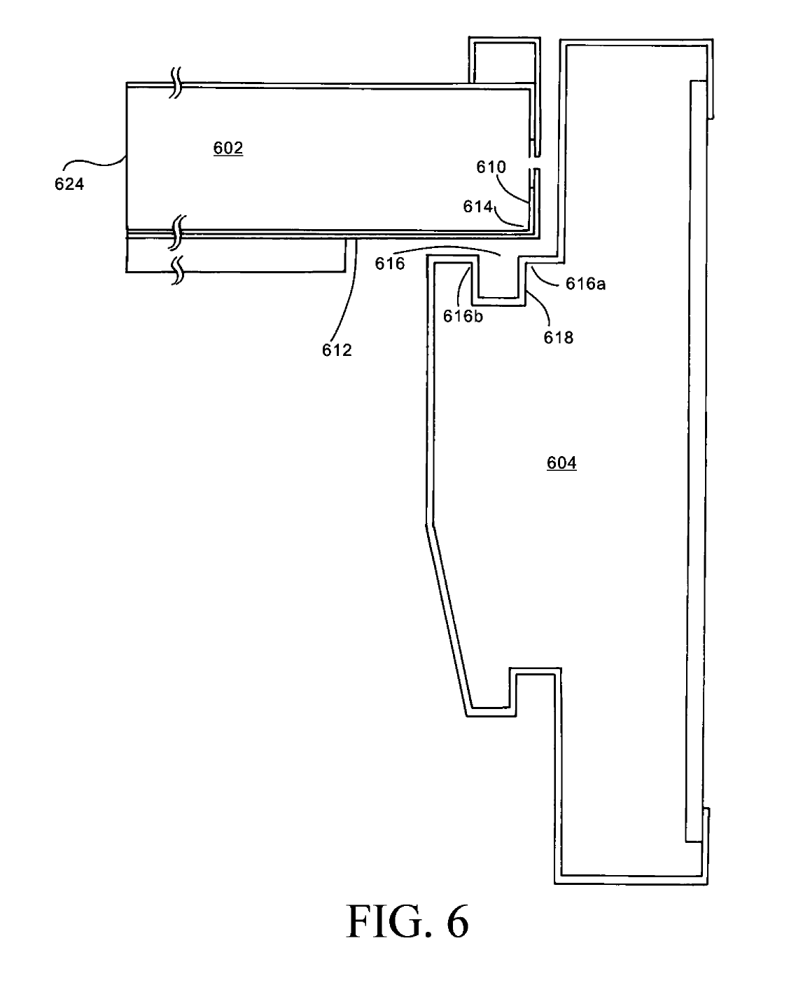

FIG. 6 is a cross-section of a door assembly according to a third embodiment of the present invention. Referring to FIG. 6, the door assembly may include a door leaf 602, a door frame 604, a first rubber strip, and a second rubber strip.

The forming method, shape and material of the first rubber strip may be the same as the first rubber strip 106 of the first preferred embodiment of the present invention. The forming method, shape and material of the second rubber strip may be the same as the second rubber strip 108 of the first preferred embodiment of the present invention.

The door leaf 620 may have an inner side 612, a first peripheral side 610 and a second peripheral side 624. The inner side 612 and the first peripheral side 610 collectively form a first corner 614 between the inner side 612 and the peripheral side 610. The door frame 620 may be along the first peripheral side 610 and the inner side 612 and on the first corner 614. The door frame 604 may have a first opening 616 on the inner side 612. The first opening 616 may be toward the inner side 612 and adjacent to the first corner 614.

The first rubber strip is on the door frame 604 and adjacent to the first corner 614. The second rubber strip is in the first opening 616. The first rubber strip and the second rubber strip are respectively contacted with the first corner 614 and the inner side 612 after the door leaf 602 is close to the door frame 604.

The door leaf 602 is close to the door frame 604 by, for example, moving the door leaf 602 toward the second peripheral side 624. The moving mechanism is often found in an automatic door. When one moves the door leaf 602 to the outside, he may not notice the first rubber strip and the second rubber strip. The strips are not noticed, because most of the second rubber strip is disposed in the opening 616, and because the first rubber strip is smaller than the second rubber strip and is distanced from the one opens the door leaf 602. The strips are not disposed on the door leaf 602, and therefore do not destroy the beauty of the door leaf 602 of the present invention.

The opening 616 may have a first side corner 616a and a second side corner 616b. Compared to the second side corner 116b, the first side corner 616a is closer to the first rubber strip. The first side corner 616a is as high as the second side corner 616b. The fold 618 may be a U-shaped fold. The U-shaped fold may have an outer width of about 13.6 mm. The opening 616 of such U-shaped fold preferably have a width of about 10 mm.

The second rubber strip 108 may be a flame retardant strip. One kind of the flame retardant strip is shown in FIG. 2. Most 108a of the second rubber strip 108 is disposed in the opening 616. A little 108b of the second rubber strip 108 is contacted with the inner side 612 of the door leaf 602. When the door assembly is experienced a fire, the second rubber strip 108 expands to keep being contacted with the door leaf 604 in a high temperature. The expansion prevents the flames or smokes from licking into a room through the door assembly of the present invention. On the other hand, the expansion prevents the flames or smokes from licking out of the door assembly if the fire is started inside the room.

One kind of the first rubber strip 106 is shown in FIG. 4. The first rubber strip 106 may eliminate noise. With the second rubber strip 108 and the first rubber strip 106, the air-closing effect is increased. If one of the strips 106, 108 is not contacted well enough, another of the strips 106, 108 may be well contacted to close the air.

In another aspect, the present invention provides a method of closing air by closing a door. The door may have a door leaf and a door frame. The door leaf may have a peripheral side and an inner side. The inner side and the peripheral side collectively form a first corner between the inner side and the peripheral side. The method may include a disposing step. In this step, a door frame is disposed along peripheral side, along the inner side, and on the first corner. The door frame may have an opening on the inner side. The opening may be toward the inner side and adjacent to the first corner. A first rubber strip is on the door frame and adjacent to the first corner. A second rubber strip may be in the opening. The first rubber strip and the second rubber strip are respectively contacted with the first corner and the inner side after the door leaf is close to the door frame.

When one opens the door leaf to the outside, he may not notice the first rubber strip and the second rubber strip. With the second rubber strip and the first rubber strip, the air-closing effect is increased. If one of the strips is not contacted well enough, another of the strips may be well contacted to close the air.

The above disclosure provides many different embodiments, or examples, for implementing different features of the invention. Also, specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention.

What is claimed is:

1. A door assembly comprising:
a door leaf having an inner side and a peripheral side, the inner side and the peripheral side collectively forming a first corner between the inner side and the peripheral side;
a door frame, along the peripheral side and the inner side and on the first corner, the door frame having an opening on the inner side, the opening being toward the inner side and adjacent to the first corner;
a first rubber strip being on the door frame and adjacent to the first corner;
a second rubber strip being in the opening, wherein the first rubber strip and the second rubber strip are respectively contacted with the first corner and the inner side after the door leaf is close to the door frame.

2. A door assembly comprising:
a door leaf having an inner side and a peripheral side, the inner side and the peripheral side collectively forming a first corner between the inner side and the peripheral side;
a door frame, along the peripheral side and the inner side and on the first corner, the door frame having an opening on the inner side, the opening being toward the inner side and adjacent to the first corner;
a first rubber strip being on the door frame and adjacent to the first corner;
a second rubber strip being in the opening, wherein the first rubber strip and the second rubber strip are respectively contacted with the first corner and the inner side after the door leaf is close to the door frame, and wherein the second rubber strip is a flame retardant strip expanding to keep being contacted with the door leaf in a high temperature.

3. The door assembly of claim 2, wherein the opening has a first side corner and a second side corner.

4. The door assembly of claim 3, the first side corner is as high as the second side corner.

5. The door assembly of claim 3, wherein the inner side of the door leaf has a second corner, and wherein the second corner is contacted with the second rubber strip when the door leaf is close to the door frame.

6. The door assembly of claim 5, wherein the first side corner is higher than the second side corner.

7. A door assembly comprising:
a first door leaf having an inner side, a first peripheral side and a second peripheral side, the inner side and the first peripheral side collectively forming a first corner between the inner side and the peripheral side, the inner side and the second peripheral side collectively forming a second corner between the inner side and the peripheral side;
a door frame, along the first peripheral side and the inner side and on the first corner, the door frame having a first opening on the inner side, the first opening being toward the inner side and adjacent to the first corner;
a first rubber strip being on the door frame and adjacent to the first corner;
a second rubber strip being in the first opening, wherein second rubber strip is a flame retardant strip expanding to keep being contacted with the door leaf in a high temperature;
a second door leaf having a doorpost, the doorpost being along the second peripheral side and the inner side and on the second corner, the doorpost having a second opening on the inner side, the second opening being toward the inner side and adjacent to the second corner;
a third rubber strip being on the doorpost and adjacent to the second corner;
a fourth rubber strip being in the second opening, wherein the third rubber strip and the fourth rubber strip are respectively contacted with the second corner and the inner side after the first door leaf is close to the door frame, and wherein the fourth rubber strip is a flame retardant strip expanding to keep being contacted with the door leaf in a high temperature.
